(19) United States
(12) Patent Application Publication
(10) Pub. No.: US 2025/0115502 A1
(43) Pub. Date: Apr. 10, 2025

(54) Method and Composition for Botanical Soil Additive to Mitigate PFAS Uptake in Plants

(71) Applicant: Orin Technologies, LLC, Verona, WI (US)

(72) Inventor: Larry Kinsman, Verona, WI (US)

(21) Appl. No.: 18/911,800

(22) Filed: Oct. 10, 2024

Related U.S. Application Data
(60) Provisional application No. 63/543,324, filed on Oct. 10, 2023.

(51) Int. Cl. C02F 3/34; A01G 29/00; C02F 1/28; C02F 101/36; C02F 103/06

(52) U.S. Cl. CPC C02F 3/348; A01G 29/00; C02F 1/283; C02F 2101/36; C02F 2103/06

(57) ABSTRACT

The present application is directed to a method of remediation of contaminants through the use of one or more bioreactors disposed within a treatment zone defined by an introduction of biochar, an aerobic contaminate degrading bacteria, about the rhizosphere of the tree. The bioreactors prevent PFAS flux to woody tissue of the tree while reducing PFAS concentration in the ground water found in the treatment zone of the bioreactor.

### CROSS-REFERENCE TO RELATED APPLICATIONS

This application claims priority to U.S. provisional patent application Ser. No. 63/543,324, filed Oct. 10, 2023, the entire contents of which is incorporated herein by reference.

### BACKGROUND OF THE INVENTION

### 1. Technical Field

The present invention relates to a method and composition for inhibiting PFAS uptake into plants and more specifically, the present invention describes a method and composition for remediation of contaminants through the administration of a bioreactor including a biochar or other sorbent medias like activated carbon, wherein the biochar and/or activated carbon is combined with contaminate degrading bacteria additive.

### 2. Background Art

The discharge of organic compounds and other contaminants into the soil and surface water can lead to contamination of surface and groundwater sources resulting in potential public health impacts. Treatment of such wastewater and the remediation of soils and groundwater contaminated with organic compounds and other contaminants has been expensive, requires considerable time, and in many cases are incomplete or unsuccessful. Of particular concern is the uptake of such organic compounds into botanical and/or plant mass through rhizosphere absorption of contaminated groundwater and soil, and the resultant presence of organic compounds and other contaminants in plant based foodstuffs.

Many different physical techniques and methods exist for the remediation of soil, groundwater and wastewater to meet the clean-up standards. Examples include dig-and-haul, pump-and-treat, biodegradation, sparging, and vapor extraction. However, meeting stringent clean-up standards is often costly, time-consuming, and often ineffective for many compounds that are recalcitrant, i.e., not responsive to such treatment. Such drawbacks are particularly true of techniques that require contaminated areas to be removed prior to treatments, i.e., ex situ methods, such as is dig-and-haul and pump-and-treat methods. Accordingly, there is a need for an effective method and composition for remediation that treats contaminates in place, i.e., in situ, and does not require movement or prior extraction of the contaminated environmental media prior to treatment.

Treatment of highly soluble but historically biologically stable organic contaminants such as Perfluoroalkyl/Polyfluoroalkyl Substances (PFAS) have also been shown to be quite difficult with conventional remediation technologies and wastewater treatment. This is particularly true as these compounds are difficult to degrade chemically, thermally, and biologically is all environments. Accordingly, sorbative remediation methods, both in situ and ex situ have become prevalent.

Biochar has been shown to be an effective ex situ treatment for various contaminants such as agricultural runoff containing nitrates, phosphates, and ammonia, mine drainage and tailings containing various heavy metals and low pH, municipal storm water, general heavy metals removal and general organic compounds. Likewise, biochar has been shown to be an effective environmental remediation tool for the remediation of contaminated soil and groundwater, whether by itself, embedded, or in conjunction with other treatments such as, reductive remediation methods (ZVM) (ZVI) and/or carbon sources, oxidative remediation methods, metal stabilization methods or combinations thereof occurring simultaneously or sequentially and the delivery of such systems by injection methods,

Biochar offers a unique substrate for biological growth making contaminant targeted biological treatment methods desirable, in inhibiting plant uptake of PFAS.

### SUMMARY

As opposed to traditional activated carbon, biochar as described herein is a sustainable, pyrolized, recycled cellulosic bio-mass product (>80% fixed carbon) derived from a proprietary blend of recycled organic materials with a high cation exchange, is described above in further detail. Biochar according to the present invention has diverse pore sizes with a minimum total surface area of up to 1,133 square meters per gram or 127 acres/lb. Biochar has numerous synergistic qualities and is relatively affordable in large quantities for remediation purposes. Biochar has the ability to provide ample usable surface area for maximizing microbial colonization and thereby an active microbial community. Due to its unique honeycomb structure, biochar has the ability to provide increased pore space for the different strains of microbes. And, biochar's affinity for organic and inorganic compounds supports maximum contact (bioavailability through high sorbency) with microbes allowing for complete degradation.

The unique absorption capability of biochar prevents exterior surface microfilm buildup providing long term remediation capabilities. This allows biochar to absorb contaminants for more productive bio-attenuation of contaminants over a longer period of time. Granular Activated Carbon (GAC) primarily adsorbs contamination to the surface of the media, which then is subject to bio-film development, preventing further adsorption. As a result, biochar has been proven to supply long term maintenance free remedial abilities over GAC. Laboratory tests have also shown that biochar has a significantly higher absorptive capacity than commercially available GAC products.

The present invention is directed to a method of reducing contamination uptake into plants comprising the steps of forming a bioreactor disposed within a treatment zone in a contaminated area containing an initial concentration of a perfluoroalkyl and/or polyfluoroalkyl substances (PFAS) contaminate, the treatment zone defined by an introduction of treatment slurry comprising biochar and an contaminate degrading bacteria additive. The bioreactor of the method defines a tree disposed within the treatment zone, the tree defining a rhizosphere in a portion of the treatment zone adjacent roots of the tree, a water impermeable sleeve disposed about the rhizosphere, and a water impermeable cap disposed about a trunk of the tree to inhibit rainwater from entering the rhizosphere. The method then concentrates the contaminate at the surface of the biochar located in the treatment zone; and, degrading the contaminate at the surface of the biochar with the contaminate degrading bacteria additive to generate a final concentration of the contaminate that is less than the initial concentration.

The present invention is directed to a substantial portion of the biochar particles of the present invention have a particle diameter of preferably between 50 microns and 4000 microns, and more preferably between 50 microns and 400 microns. While these particle diameters are included herein as one embodiment of the present invention, it should be understood that the invention need not be limited to such dimensions.

The present invention is directed to a substantial portion of the biochar particles have a particle size of between 50 microns and 4000 microns.

The present invention is directed to the biochar constituting a catalyzing agent for the formation of free radicals of the oxidizing agent.

The soil conditioner of the present invention includes biochar derived from plants. It may include but is not limited to biochars formed from wood, grass, manure, grain husks, saw dust, etc. The biochars may be chars produced by conventional charring methods or, alternatively within the scope of this invention, the biochars may be produced with an additional activation step such as acid treatment, high pressure steam, etc.

The soil conditioner may further include one or more additives or adjusting substance selected from one of microorganisms, enzymes, preservatives, antioxidants, nutrient additive, acidity regulators and quality improving agents. The soil conditioner is made by infusing biochar with one or more additives and or carrier. The soil conditioner improves soil aggregation and moisture and nutrient retention capacity. Thus, the soil conditioner may be added to soil to improve crop production and stabilize soil, for example, in conditions of high wind or desertification.

The present invention is directed to the application of a soil conditioner including at least a biochar component configured to reduce and/or eliminate PFAS uptake into the agricultural plant. In another aspect of the present invention, the biochar containing soil additive is applied about the plant as to inhibit PFAS uptake within the plant to a level below a medically significant sample.

The present invention is directed to a field for agricultural production, wherein the present invention particularly discloses a biochar-based fertilizer with optional nutrition and improvement functions, which comprises biochar mixed materials and one or more optional organic fertilizer materials, additional mixed materials.

The present invention is directed to a volume of biochar containing fertilizer is applied in a quantity sufficient to inhibit PFAS uptake into a plant to a level less than a medically significant threshold.

The present invention is directed to a treatment area, which may be a marsh, including a plurality of bioreactors disposed in breams located within a semipermeable biochar and aggregate base that allows for the remediation of water flowing through the marsh.

Although the best mode contemplated for carrying out the present invention is disclosed above, practice of the above invention is not limited thereto. It will be manifest that various additions, modifications and rearrangements of the features of the present invention may be made without deviating from the spirit and the scope of the underlying inventive concept.

### BRIEF DESCRIPTION OF THE DRAWINGS

FIG. 1 is a cross-sectional schematic view of a treatment zone including three bioreactors according to an embodiment of the present invention;

FIG. 2 is top plan view of a treatment marsh being one embodiment of a treatment zone according to the present invention; and,

FIG. 3 is a cross-sectional view of the treatment marsh of FIG. 2 taken alone line 3-3.

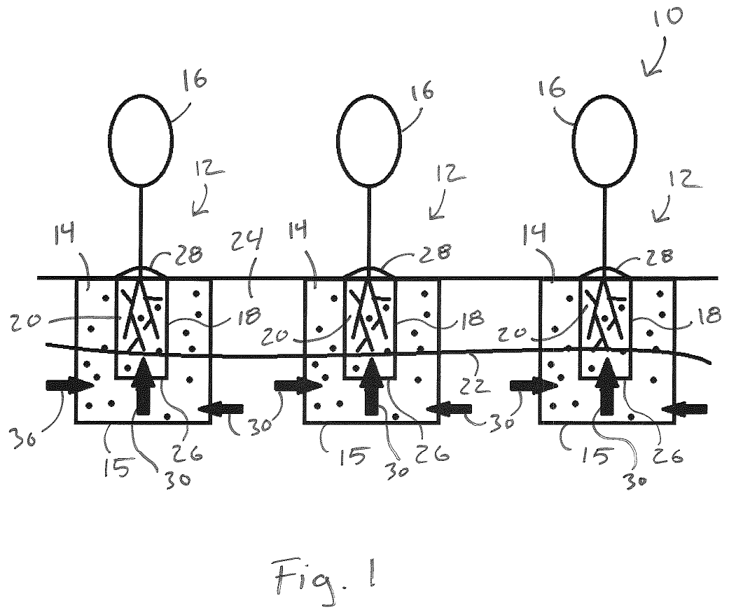

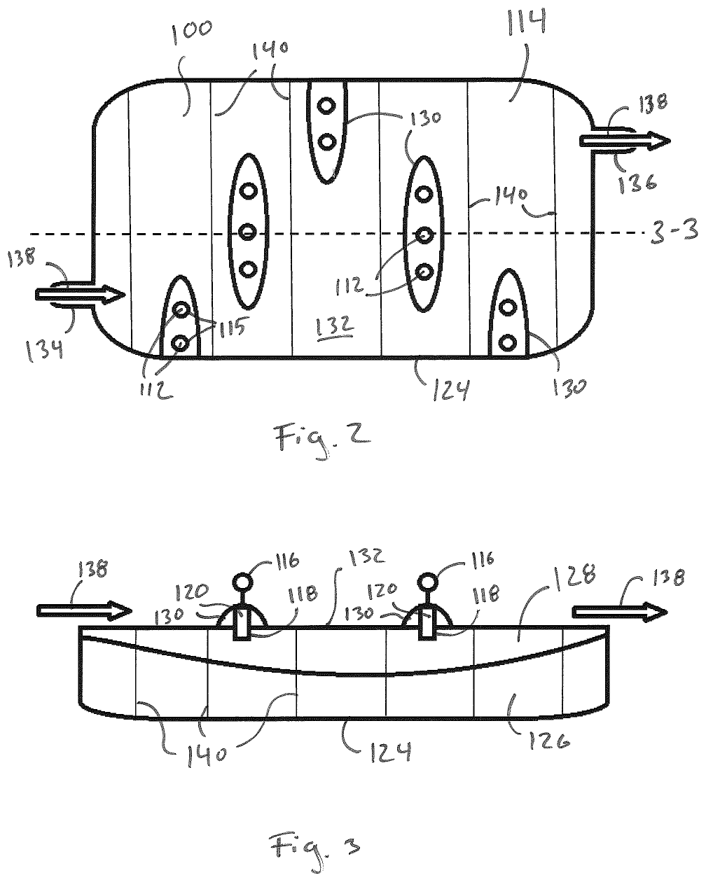

### DETAILED DESCRIPTION

The present disclosure provides a method of contamination remediation and inhibiting contamination uptake into botanical, agricultural, or plan materials via contaminated groundwater. In an embodiment, the method of organic contamination remediation includes the steps of: forming a bioreactor disposed within a treatment zone in a contaminated area containing an initial concentration of a perfluoroalkyl and/or polyfluoroalkyl substances (PFAS) contaminate. The treatment zone is defined by an introduction of treatment slurry comprising biochar and an contaminate degrading bacteria additive. The bioreactor defines a tree disposed within the treatment zone, the tree defining a rhizosphere in a portion of the treatment zone adjacent roots of the tree, a water impermeable sleeve disposed about the rhizosphere, and a water impermeable cap disposed about a trunk of the tree to inhibit rain water from entering the rhizosphere. The method includes concentrating the contaminate at the surface of the biochar located in the treatment zone; and, degrading the contaminate at the surface of the biochar with the contaminate degrading bacteria additive to generate a final concentration of the contaminate that is less than the initial concentration.

The process may include providing an oxygen source, as described below. The oxygen source is selected from a group consisting of peroxygens and/or oxygen electrically generated via electrodes placed within the treatment zone, air sparging, gas diffusion or a combination thereof. The electrode may further comprise an electrolysis and/or electokinetic system that may alternate and/or pulse at a duration of 0.1 ms to 10 s. A low operating voltage of approximately 1 to 100 volts, and preferably 10 to 40 volts is supplied throughout the electokinetic system. Optionally the electrokinetic system may further provide a low current density. IN a preferred embodiment the oxygen source is sufficient to maintain an aerobic environment in the treatment zone as to maintain the population of acrobic contaminate degrading bacteria.

The process includes degradation of a PFAS and/or PCE contaminate. In an embodiment the PFAS is selected from a group consisting of Perfluorooctane sulfonic acid (PFOS), Perfluoroheptanesulfonic acid (PFHpS), Perfluorohexanesulphonic acid (PHHxS), Perfluoropentane sulfonic acid (PFPeS). Perfluorobutane sulfonate (PFBS), Perfluorooctanoic acid (PFOA), Perfluorohexanoic acid (PFHxA), perfluoropentanoic acid (PFPeA), and Perfluorobutanoic acid (PFBA), and combinations thereof. In an embodiment, the final concentration of the contaminate is less than 5% of the initial concentration. In an embodiment. the final concentration of the contaminate is less than 3% of the initial concentration. In an embodiment, the final concentration of the contaminate is less than 1% of the initial concentration. In an embodiment, the final concentration of the contaminate is less than the applicable regulatory threshold for groundwater and/or soil levels of PFAS and/or PCE.

The process includes providing and aerobic contaminate degrading bacteria additive. In an embodiment the aerobic contaminate degrading bacteria additive is selected from a group consisting of Pseudomonas, Rhodococcus, Pseudonocardia, Bacillus, Actinomycetota, and combinations thereof. In an embodiment the aerobic contaminate degrading bacteria additive bacteria comprises at least in-part an aerobic methanotrophic bacteria.

The process includes providing a biochar. In an embodiment the biochar is in slurry form that comprises from 2 wt %, or 4 wt %, or 6 wt %, or 8 wt % or 10 wt % to 12 wt %, or 13 wt %, or 15 wt %, or 17 wt %, or 20 wt %, or 25 wt % biochar based on the total weight of the slurry. In an embodiment, the biochar is formed of a plurality of particles having a net surface area of greater than or equal to 500, or 600, or 700, or 800, or 900, 1000 square meters per gram and less than or equal to 1,200, or 1,400, or 1,500 or 1,700, or 2,000 or 2,200 square meters per gram. In an embodiment the biochar particles have a particle size of between 0.5 microns or 1 micron, or 2 microns, or 5 microns, or 10 microns, or 25 microns, or 40 microns and 2000 microns, or 3000 microns, or 4000 microns, or 5000 microns. In an embodiment the slurry is a dilution comprising between 2%, or 4%, or 7.5%, or 9% and 9.5%, or 10%, or 12.5%, or 15% or 20% combined biochar and the aerobic contaminate degrading bacteria additive suspended in a fluid carrier based on the total volume of the slurry. In an embodiment the fluid carrier is water.

In an embodiment the treatment zone is an in situ treatment zone. The in situ treatment zone may further define a bioreactor including a plant, such as a tree planted in or above the treatment zone, such that the plant or tree is configured to capture mobile short chain compounds, i.e., (C<4).

### Experimental Example

Test site is a former industrial site which operated from the 1890s to the 1950s. The former industrial buildings burned to the ground in 2005. Prior use of Aqueous Film Forming Foam (AFFF) at the industrial site is suspected. PFAS has been detected on site in both soil and groundwater at levels that exceed applicable drinking water and groundwater surface water interface (GSD) criteria. Municipal water is available in the area, and the principal risk associated with PFAS at this site is migration of PFAS to the adjacent river and lake. Seasonally. PFAS impacted groundwater has vented to the ground surface and the former industrial site's storm water infrastructure.

Procedures performed on site in accordance with the present invention included the formation of a series of bioreactors 12 throughout the contaminated area 10 to form a treatment zone 14. The treatment zone 14 formation included the injection and mechanically mixed biochar to immobilize PFAS in the impacted, unconsolidated shallow groundwater at the contaminated area 10 to test the capability of phytoremediation of PFAS impacted groundwater using a combination of strategies. Biochar was mixed at an approximately 6 to 10% by volume of soil, and more preferably 7 to 8% and dispersed into 8 foot wide trenches 15 in the ground at the contaminated area 10. The trenches 15 were placed approximately 4 feet apart, provide conductive channels to ensure ground water supply to trees 16 and enhance PFAS migration into the biochar treatment media. Tree species 16 were planted overtop of the trenches with a sleeve 18 disposed about the rhizosphere 20 of each tree 16 as to isolate the rhizosphere 20 above the water table 22 from the surrounding vadose soil 24 and rainwater seepage. The sleeve 18 may have a depth of between 4 feet and 10 feet, and be selected to accommodate the rhizosphere of the corresponding species of tree 16. The sleeve 18 is not water permeable, thereby forcing the tree to uptake PFAS impacted groundwater through the open bottom end 26 of the sleeve 18 in order for the tree to grow. A cap or seal 28 is placed around the tree at the surface to prevent rainwater infiltration-thereby forming a controlled bioreactor 12 about the isolated treewell that uptakes PFAS impacted groundwater, as shown by arrows 30. Biochar and microbes were added to the bioreactors 12, at a concentration of approximately twice that of the surrounding trenches 16, i.e., biochar was mixed at an approximately 15 to 20% by volume of soil. In addition PFAS degrading microbes were inoculated into the bioreactors 12.

In groundwater samples for the bioreactors 12 and tree 16 tissue samples were periodically analyzed. Results demonstrate significant reduction in PFAS present in groundwater samples, and at least below applicable drinking water and ground surface water interface (GSI) criteria, as to demonstrate that utilizing biochar combined with or without microbes can stop and/or significantly reduce the uptake of PFAS (and likely other contaminates) into trees and plants. And thereby reduce the spread of PFAS into the environment and the food chain of people and animals. Samples for PFAS uptake into tree 16 tissue were tested for eight bioreactors versus a control, as shown below in Table 1.

TABLE 1

| Control | | |
|---|---|---|
| 1 | 2 | 3 |

| Tree Type | | | |
|---|---|---|---|
| Willow | Willow | Poplar | Willow |

Tree Tissue

| Analyte | Acronym | Leaf | Leaf | Leaf | Root | Trunk | Shoot | Leaf |
|---|---|---|---|---|---|---|---|---|
| Perfluorobutanoic acid | PFBA | 21.0 | 4.50 | 3.90 | U | U | U | 1.30 J |
| Perfluoropentanoic acid | PFPeA | 39.0 | 2.20 | 1.20 | U | U | U | U |
| Perfluorohexanoic acid | PFHxA | 5.80 | 0.49 J | U | U | U | U | U |
| Perfluoroheptanoic acid | PFHpA | 1.40 | U | U | U | U | U | U |
| Perfluorooctanoic acid | PFOA | 1.60 | U | U | U | U | U | U |
| Perfluorononanoic acid | PFNA | 0.46 J | U | U | U | U | U | U |
| Perfluorobutane | PFBS | 11.0 | 0.51 | U | U | U | U | U |
| Sulfonate | | | | | | | | |
| Perfluoropentanesulfonic | PFPeS | 14.0 | 1.10 | U | U | U | U | U |
| acid | | | | | | | | |
| Perfluorohexanesulfonic | PFHxS | 70.0 | 3.50 | U | U | U | U | 0.51 |
| acid | | | | | | | | |
| Perfluoroheptanesulfonic | PFHpS | 1.20 | U | U | U | U | U | U |
| acid | | | | | | | | |
| Perfluorooctanesulfonic | PFOS | 22.0 | 0.73 | U | U | U | U | U |
| acid | | | | | | | | |
| Calculated total PFAS | T-PFAS | 187 | 13.0 | 5.10 | — | — | — | 1.81 |
| Total organic fluorine | TOF | — | — | — | 1200 J | U | U | u |

| | | |
|---|---|---|
| 4 | 5 | 6 |
| Poplar | Poplar | Willow |

| Root | Trunk | Shoot | Leaf | Leaf | | Trunk | Shoot | Leaf | Leaf |
|---|---|---|---|---|---|---|---|---|---|
| U | U | U | 2.40 | 2.60 | 4.50 | U | U | 1.80 J | 6.20 |
| U | U | U | u | 0.63 | 0.93 | U | U | 1.00 | 4.40 |
| U | U | 0.31 J | U | U | UY | U | U | U | 0.53 |
| U | U | U | U | U | U | U | U | U | U |
| U | U | U | U | U | U | U | U | U | U |
| U | U | U | U | U | U | U | U | U | U |
| U | U | U | U | U | U | U | U | U | 0.55 |
| U | U | U | U | U | U | U | U | U | 0.73 |
| U | U | U | U | U | 0.45 J | U | U | 0.92 | 3.30 |
| U | U | U | U | U | u | U | U | U | U |
| U | U | U | U | U | 0.31 J | U | U | U | 0.65 |
| — | — | 0.31 | 2.40 | 3.23 | 6.19 | — | — | 3.72 | 16.4 |
| U | U | U | U | U | — | U | U | U | — |

| | |
|---|---|
| 7 | 8 |
| Willow | Cedar |
| Leaf | Leaf |

| | | | |
|---|---|---|---|
| 1.30 J | 4.40 | 0.59 J | 0.43 J |
| 0.42 J | 1.60 | U | U |
| U | U | U | U |
| U | U | U | U |
| U | U | U | U |
| U | U | U | U |
| U | U | U | U |
| U | U | U | U |
| 1.1 | 0.83 | U | U |
| U | U | U | U |
| U | U | U | U |
| 2.82 | 6.83 | 0.59 | 0.43 |
| U | — | U | — |

All per- and polyfluoroalkyl substances (PFAS) results/screening levels in nanograms per liter (ng/g; i.e. parts per billion).
U = Undetected at the limit of quantitation.
J = Estimated concentration between the estimated detection limit and reportable detection limit.

More specifically, in a control tree, i.e., bioreactor 12, the bioaccumulation of PFAS in a leaf tissue during a testing period, consisting of 30 days, was equal to approximately 88 ng/g in total wherein the identified PFAS are selected from a list of long chain and short chain (C<4) PFAS, including Perfluorooctane sulfonic acid (PFOS), Perfluoroheptanesulfonic acid (PFHpS), Perfluorohexanesulphonic acid (PHHxS), Perfluoropentane sulfonic acid (PFPeS),

Perfluorobutane sulfonate (PFBS), Perfluorooctanoic acid (PFOA), Perfluorohexanoic acid (PFHxA), perfluoropentanoic acid (PFPeA), and Perfluorobutanoic acid (PFBA), and combinations thereof. In contrast, in six experimental trees, i.e., bioreactors 12, which include the addition of biochar and microbes into the the bioaccumulation of PFAS in a leaf tissue during a testing period, consisting of 30 days, was recorded and identified as less than or equal to 4.0 ng/g PFAS in average. That is to say the experimental bioreactors exhibited a greater than 95% reduction in PFAS compared to the control. Furthermore, the experimental bioreactors 12 exhibited a greater than 85% reduction in PFHxS, and PFOS, and a nondetectable, i.e., greater than 99% reduction in PFHpS, PFPCS, PFBS, PFOA, PFHZA, PFPeA, and combinations thereof.

Furthermore, in the control tree, i.e., bioreactor 12, the bioaccumulation of PFAS in groundwater sampled from within the bioreactor 12 during a testing period, consisting of 30 days, was equal to approximately 23 μg/g, in total wherein the identified PFAS are again selected from a list including Perfluorooctane sulfonic acid (PFOS), Perfluoroheptanesulfonic acid (PFHpS), Perfluorohexanesulphonic acid (PHHxS), Perfluoropentane sulfonic acid (PFPeS), Perfluorobutane sulfonate (PFBS), Perfluorooctanoic acid (PFOA), Perfluorohexanoic acid (PFHxA), perfluoropentanoic acid (PFPeA), and Perfluorobutanoic acid (PFBA), and combinations thereof. In contrast, in six experimental trees, i.e., bioreactors 12, the bioaccumulation of PFAS in a groundwater sampled from within the bioreactors during a testing period, consisting of 30 days, was recorded and identified as less than or equal to 2.0 μg/g PFAS in average. That is to say the experimental bioreactors exhibited a greater than 91% reduction in PFAS compared to the control. Furthermore, the experimental bioreactors exhibited a greater than 85% reduction in PFHxS, and PFOS, and a nondetectable, i.e., greater than 99% reduction in PFHpS, PFPeS, PFBS, PFOA, PFHZA, PFPeA, and combinations thereof. Furthermore, the experimental bioreactors 14 demonstrated that biochar absorption of PFAS and degradation thereof, inhibits PFAS flux to tree woody tissues, such that long chain PFAS were absent in treated leaf tissue, and a decreased rate of uptake for shorter chain (C<4) PFAS in leaves compared to control trees. Moreover, the phyto-containment of PFBA and other short chain PFAS was limited to leaf structure. In contrast to the bioreactors 14 of the present invention, control trees show high affinity to uptake PFBA from groundwater including full suite of all PFAS, which present a risk of highly contaminated trees and recontamination of surface from contaminated tissues

In another embodiment, the pH of the groundwater of the experimental bioreactors 12 was controlled during a testing period of 30 days. A first group of three experimental bioreactors have a bioreactor pH of between 6.5 and 7.0. A second group of five experimental bioreactors have a bioreactor pH of greater than 9.0. After a 30 day test period, while both groups exhibited a greater than greater than 91% reduction in PFAS (μg/L) in groundwater, the first group having a bioreactor pH of between 6.5 and 7.0 exhibited a greater than 98% reduction of PFAS (μg/L) in groundwater and did not exceed applicable regulatory concentration threshold.

In sum, the biochar and microbial treatment of the test bioreactors was determined to be successful in combination with phytoremediation. Biochar and mircorbial treatments immobilize PFAS and reduce flux into the plant rhizosphere, while the tree simultaneously captures mobile short chain compounds, i.e., (C<4). In addition, groundwater samples achieved regulatory concentration compliance via the reduction of PFAS after 30 days in bioreactors with a pH of 6.5-7.0.

As applied to agricultural applications, the above referenced use of biochar in

combination with a microbial treatment may be used as a soil conditioner configured to reduce and/or eliminate PFAS uptake into the agricultural plant as to immobilize PFAS and reduce flux into the agricultural plant rhizosphere. More specifically, such use of the the biochar containing soil additive is applied about an agricultural plant may particularly inhibit PFAS uptake within the plant to a level below a medically significant sample.

In an alternative embodiment of the present invention, the procedures performed on in accordance with the present invention include the formation of a series of bioreactors 112, which may correspond to the bioreactors 12 of the embodiment described above, disposed within a contaminated area 100 to form a treatment zone, or treatment marsh 114. The treatment marsh 114 is preferably a manmade in-ground treatment marsh 114, comprising a plurality of bioreactors 112. Each bioreactor 112 includes a volume of biochar was mixed at an approximately 6 to 10% by volume of soil, and more preferably 7 to 8% and dispersed into approximately an 8 foot wide hole 115 in the contamination area 100, in lieu of a trench 15 from embodiment 1. Tree species 116 were planted within of the holes 115 with a sleeve 118 disposed about the rhizosphere 120 of each tree 116 as to isolate the rhizosphere 120 above the water table from the surrounding vadose soil and rainwater seepage. The sleeve 118 may have a depth of between 4 feet and 10 feet, and be selected to accommodate the rhizosphere of the corresponding species of tree 16. The sleeve 18 is not water permeable, thereby forcing the tree to uptake PFAS impacted groundwater through the open bottom end of the sleeve 118 in order for the tree to grow. A cap or seal is placed around the tree at the surface to prevent rainwater infiltration-thereby forming a controlled bioreactor 112 about the isolated treewell that uptakes PFAS impacted water in the treatment march 114, as shown by arrows 122. Biochar and microbes were added to the bioreactors 112, at a concentration of approximately twice that of the surrounding trenches 16, i.e., biochar was mixed at an approximately 15 to 20% by volume of soil. In addition PFAS degrading microbes were inoculated into the bioreactors 112.

In this embodiment, the outer and/or bottom wall 124 of the treatment marsh 114 may be formed of a packed clay or alternative impermeable material, such as a to form a confining layer between the treatment marsh 114 and the surrounding area. A base layer 126 including a mixture of sand and biochar is then disposed over the wall 124. The base layer 126 includes a volume of biochar mixed at an approximately 4 to 20% by volume of sand, and more preferably 5 to 10%. An intermediate layer 128, including a mixture of gravel and biochar is then disposed over the base layer 126. The intermediate layer 128 includes a volume of biochar mixed at an approximately 4 to 20% by volume of gravel, and more preferably 5 to 10%. The larger particulate sizes of the gravel, ranging from approximately 1 cm to 5 cm in diameter, in the intermediate layer 128 relative to the sand in the base layer 126, provides for an increase in the interparticular space in the intermediate layer 128. Resultantly, a treatment marsh 114, of approximately 1 acre in surface area, and having a depth of approximately 4 to 5 feet, where both the base layer 126 and intermediate layer 128 have a depth of approximately 2 to 3 feet, is configured to retain approximately 1,000,000 gallows of water therein for remediation.

Disposed above the intermediate layer are one or more berms 130, or elongated raised soil embankments. As illustrated, each of the one or more berms 130 may be formed above and supported by the intermediate layer 128. The plurality of bioreactors 112, as was described above are configured to be disposed within the berms 130, such that the tree 116 uptake PFAS impacted water that is traveling through intermediate layer 128, via the open bottom end of the sleeve 118 in order for the tree 116 to grow. A surface covering 132, such as a planting mat or bio-mesh mat may be disposed about the upper surface of the intermediate layer 128, between the berms 130, as to support small plant such as grasses, in a biochar rich environment, thereby further promoting PFAS concentration on the biochar, and removal from treatment water.

The treatment marsh 114, may include a water inlet 134 on an upstream end for input of PFAS containing water, and a water outlet 136 on a downstream end for phytoremediated water. The direction of water travel is shown with arrow 138. In one embodiment the water may flow from inlet 134 to outlet 136 via gravitational force, or be pumped. Alternatively, the treatment marsh 114, may include a series of vertically separated levels, such that a single mash 114 is terraced, or alternatively comprises a series of individual marshes 114 in a terraced system. I yet another embodiment, the marsh 114, may be a stagnant or still treatment marsh 114, in which there is no active movement of the water contained therein.

Still referring to the illustrated embodiment, the treatment marsh 114, may further include one or more aerating supplements 140. Such aerating supplements 140 may include, but are not limited to an oxygen source selected from a group consisting of peroxygens and/or oxygen electrically generated via electrodes placed within the treatment marsh 114, air sparging, gas diffusion or a combination thereof. Such an electrode may further comprise an electrolysis and/or electokinetic system that may alternate and/or pulse at a duration of 0.1 ms to 10 s A low operating voltage of approximately 1 to 100 volts, and preferably 10 to 40 volts is supplied throughout the electokinetic system. Optionally the electrokinetic system may further provide a low current environment in the treatment marsh as to maintain the population of aerobic contaminate degrading bacteria therein.

As previously described, bioreactors 114 according to the present invention has exhibited a greater than 91% reduction in PFAS compared to that of a control. Furthermore, the experimental bioreactors 114 exhibit a greater than 85% reduction in PFHxS, and PFOS, and a nondetectable, i.e., greater than 99% reduction in PFHpS, PFPeS, PFBS, PFOA, PFHZA, PFPeA, and combinations thereof.

In sum, the biochar and acrobic microbial treatment of the bioreactors 114 is a successful combination with phytoremediation. Biochar and mircorbial treatments immobilize PFAS and reduce flux into the plant rhizosphere, while the tree 116 simultaneously captures mobile short chain compounds, i.e., (C<4). In addition, water samples achieved regulatory concentration compliance via the reduction of PFAS after 30 days in bioreactors 116 with a pH of 6.5-7.0.

It should be understood that the invention is not limited in its application to the details of construction and arrangements of the components and method steps set forth herein. The invention is capable of other embodiments and of being practiced or carried out in various ways by those skilled in the art. Variations and modifications of the foregoing are within the scope of the present invention. It is also understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

What is claimed is:

1. A method of contamination remediation comprising the steps of:
forming a bioreactor disposed within a treatment zone in a contaminated area containing an initial concentration of a perfluoroalkyl and/or polyfluoroalkyl substances (PFAS) contaminate,
the treatment zone defined by an introduction of treatment slurry comprising biochar and an contaminate degrading bacteria additive;
the bioreactor defining a tree disposed within the treatment zone, the tree defining a rhizosphere in a portion of the treatment zone adjacent roots of the tree,
a water impermeable sleeve disposed about the rhizosphere, and
a water impermeable cap disposed about a trunk of the tree to inhibit rain water from entering the rhizosphere:
concentrating the contaminate at the surface of the biochar located in the treatment zone; and,
degrading the contaminate at the surface of the biochar with the contaminate degrading bacteria additive to generate a final concentration of the contaminate that is less than the initial concentration.

2. The method of claim 1, further comprising an oxygen source disposed within the bioreactor.

3. The method of claim 2, wherein the oxygen source is selected from a group consisting of peroxygens and/or oxygen electrically generated via electrodes placed within the treatment zone, air sparging, gas diffusion or a combination thereof.

4. The method of claim 1, wherein the PFAS is selected from a group consisting of Perfluorooctane sulfonic acid (PFOS), Perfluoroheptanesulfonic acid (PFHpS), Perfluorohexanesulphonic acid (PHHxS), Perfluoropentane sulfonic acid (PFPeS), Perfluorobutane sulfonate (PFBS), Perfluorooctanoic acid (PFOA), Perfluorohexanoic acid (PFHxA), perfluoropentanoic acid (PFPeA), and Perfluorobutanoic acid (PFBA), and combinations thereof.

5. The method of claim 1, wherein the contaminate degrading bacteria additive is an aerobic contaminate degrading bacteria additive.

6. The method of claim 5, wherein the aerobic contaminate degrading bacteria additive is selected from a group consisting of Pseudomonas, Rhodococcus, Pseudonocardia, Bacillus, Actinomycetota, and combinations thereof.

7. The method of claim 1, wherein treatment slurry comprises from 6-10% volume biochar based on the total weight of the treatment slurry.

8. The method of claim 7, wherein the treatment slurry disposed within the rhizosphere comprises from 15-20% volume biochar.

9. The method of claim 1, wherein the biochar is formed of a plurality of particles having a net surface area of greater than or equal to 900 square meters per gram and less than or equal to 1,500 square meters per gram and wherein the particles have a particle size of between 0.5 microns and 4000 microns.

10. The method of claim 1, wherein the final concentration of the contaminate is less than 10% of the initial concentration.

11. The method of claim 4, wherein the final concentration of the contaminate is less than 1% of the initial concentration, when the contaminate is selected from a group consisting of one or more of PFHpS, PFPeS, PFBS, PFOA, PFHZA, PFPeA, and combinations thereof.

12. The method of claim 1, wherein the pH of the rhizosphere is maintained between 6.5 and 7.0.

13. The method of claim 12, wherein the final concentration of the contaminate is less than 2% of the initial concentration.

14. The method of claim 4, wherein long-chain PFAS are absent from woody tissue of the tree in the bioreactor.

15. A system for use in the remediation of an organic contaminant comprising:
a bioreactor having:
a tree having a rhizosphere disposed within a water impermeable sleeve, the sleeve having an open bottom end and a water impermeable cap at a top end located about a trunk of the tree configured to inhibit rain water from entering the rhizosphere;
a biochar slurry disposed about the rhizosphere including:
a volume of soil,
a volume biochar formed of a plurality of particles having a net surface area of greater than or equal to 900 square meters per gram and less than or equal to 1,500 square meters per gram, wherein the particles have a particle size of between 0.5 microns and 4000 microns,
an aerobic contaminate degrading bacteria selected from a group consisting of Pseudomonas, Rhodococcus, Pseudonocardia, Bacillus, Actinomycetota, and combinations thereof; and
wherein the bioreactor disposed within a treatment zone is configured to degrade an initial concentration of a perfluoroalkyl and/or polyfluoroalkyl substances (PFAS) contaminate in the treatment zone to a final concentration that is less than 10% of the initial concentration.
